(19) United States
(12) Patent Application Publication
(10) Pub. No.: US 2005/0114237 A1
(43) Pub. Date: May 26, 2005

(54) Inventory forecasting system

(76) Inventor: John C. Urso, Southgate, MI (US)

Correspondence Address: HARNESS, DICKEY & PIERCE, P.L.C., P.O. BOX 828, BLOOMFIELD HILLS, MI, 48303, US

(21) Appl. No.: 10/723,286

(22) Filed: Nov. 26, 2003

(51) Int. Cl. G06F 17/60

(52) U.S. Cl. 705/28

(57) ABSTRACT

An inventory forecasting system includes an input receptive of a product total and a probability of product failure over a predetermined amount of time. A gross material plan for a lifetime, such as a product service term or portion thereof, is determined based on the product total and the probability of product failure. A releasing plan is devised to accomplish automatic release of products to a supply base based on volume assumptions determined as a function of the gross material plan.

### BACKGROUND AND SUMMARY OF THE INVENTION

The present invention generally relates to inventory forecasting systems, and particularly relates to forecasting of product demand based on statistically averaged probabilities of product failure over a service term.

Forecasting demand for products, such as vehicle parts, is a problem that has typically been approached with logarithmic systems. These logarithmic systems have usually employed planes of data developed from past demand history in an attempt to forecast future demand. These systems, however, have often proven to be inaccurate and have normally achieved only a twenty-five to fifty-percent accuracy rate. Inaccurate results of conventional systems are distressing to manufacturers, suppliers, and related parties because the ramifications of poor product demand forecasting are sweeping.

Poor product demand forecasting typically results in too many or two few products being produced and stored over extensive periods of time. Disadvantages resulting from product shortage include higher costs due to additional set ups and customer dissatisfaction due to delay. Disadvantages resulting from product overage include higher costs due to over-utilized storage resources and unsold products. Therefore, the need remains for a product demand forecasting system that achieves a high degree of accuracy.

In accordance with the present invention, an inventory forecasting system includes an input receptive of a product total and a probability of product failure over a predetermined amount of time. In another aspect of the invention, a gross material plan for a lifetime, such as a product service term or portion thereof, is determined based on the product total and the probability of product failure. A further aspect of the invention provides a releasing plan which is devised to accomplish automatic release of products to a supply base based on volume assumptions determined as a function of the gross material plan. Alternatively or additionally in still another aspect of the present invention, a customer quote is based on an individual product price determined as a function of the gross material plan. Alternatively or additionally, an income statement is based on the individual product price and a product volume determined as a function of the gross material plan.

The inventory forecasting system of the present invention is advantageous over traditional methods since the present invention saves money, reduces unneeded inventory space, and increases customer satisfaction. These advantages are obtained by the increased forecasting accuracy of the present invention. The increased accuracy is realized by use of statistically formulated actuarial tables or equivalents providing reliable probabilities of product failure over time.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a flow diagram illustrating the inventory forecasting method according to the present invention;

FIG. 2 is a block diagram illustrating actuarial table development and organization according to the present invention;

FIG. 3 is a block diagram illustrating the inventory forecasting system according to the present invention;

FIG. 4 is a block diagram illustrating staggered production cost determination according to the present invention;

FIG. 5 is a block diagram illustrating roll out set up cost determination according to the present invention;

FIG. 6 is a block diagram illustrating product storage, freight, labor, and packaging costs determination in accordance with the present invention; and

FIG. 7 is a block diagram illustrating individual product price determination in accordance with the present invention.

### DETAILED DESCRIPTION OF THE PREFERRED EMBODIMENT

The following description of the preferred embodiment is merely exemplary in nature and is in no way intended to limit the invention, its application, or uses.

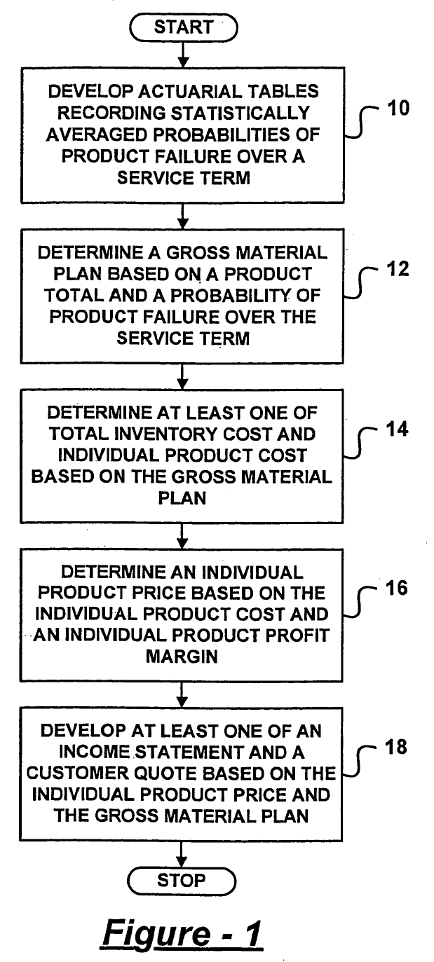

Starting with FIG. 1, the inventory forecasting method according to the present invention includes use of actuarial tables recording statistically averaged probabilities of product failure over a service term. These actuarial tables are developed as an actuarial module at step 10 and employed at step 12 to determine a gross material plan for a lifetime based on a product total and a probability of product failure over a service term. The gross material plan for a lifetime corresponds to a percentage of the product total that will need to be replaced during the service term due to product failure. The gross material plan is broken down into periods of the service terms based on volume assumptions determined as a function of the gross material plan and a fraction of the service term. Thus, the gross material plan serves as a releasing plan designed to accomplish automatic product release to a supply base.

Total inventory cost for the entire service term or for a portion of the service term is determined based on the gross material plan at step 14, and this cost is similarly broken down into periods of the service term in which they are incurred. Alternatively or additionally, an individual product cost may be determined at step 14 based on the gross material plan. Thus, an individual product price is determined at step 16 based on the individual product cost and a profit margin. Accordingly, it is possible to develop a customer quote, an income statement, or similar information based on the individual product price and the gross material plan at step 18.

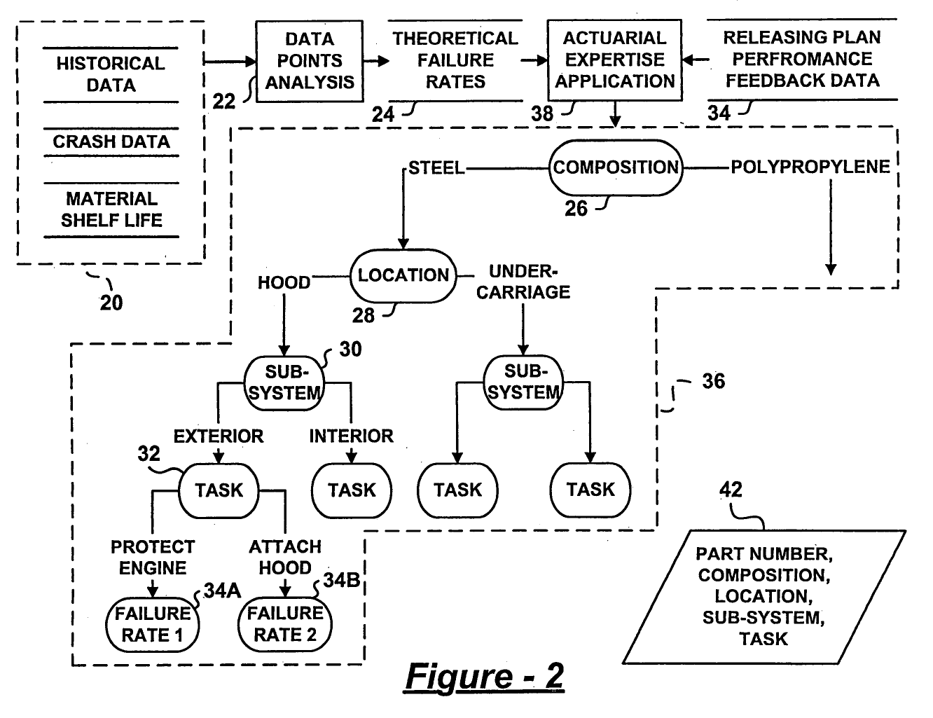

Turning now to FIG. 2, actuarial table development and organization is illustrated. Failure rate data 20 is broken down into data points and analyzed at failure analysis module 22 to obtain theoretical failure rates 24 as statistically averaged probabilities of product failure over a predetermined service term. In a preferred embodiment, vehicle part failure rates are determined based on historical data, vehicle crash data in the public domain, and material shelf life. Actuarial expertise is applied to statistically determine failure rates 24 for product categories including product composition 26, product location 28, product sub-system 30, and product function 32. Tracked anomalies in related releasing results are used as feedback 34 to modify the resulting actuarial table 36 by further application of actuarial expertise at 38.

The resulting actuarial table or module 36 therefore takes the form of a hierarchical tree-like data structure with edges corresponding to subcategories, and leaf nodes 40A and 40B containing probabilities of failure for automotive vehicle parts. For example, vehicle part data 42 corresponds to a hood of a vehicle that is made of steel, located in the hood region, part of the vehicle exterior sub-system, with an engine protection function. Assuming that node 40A stores the failure rate for vehicle hoods, corresponding traversal of the tree-like data structure returns the failure rate for a vehicle hood. It is envisioned that different actuarial tables are developed for different vehicle types, such as truck and car. It is also envisioned that different actuarial tables are developed for different vehicle makes and models. It is further envisioned that actuarial tables according to the present invention may include categories for vehicle type, make, model, and similar distinctions. It should be readily understood that the present invention is not limited to use with vehicle parts, but may be readily employed with various kinds of products that may or may not correspond to parts of another product, such as replacement parts for aircraft, machines, retail merchandise, books, and the like.

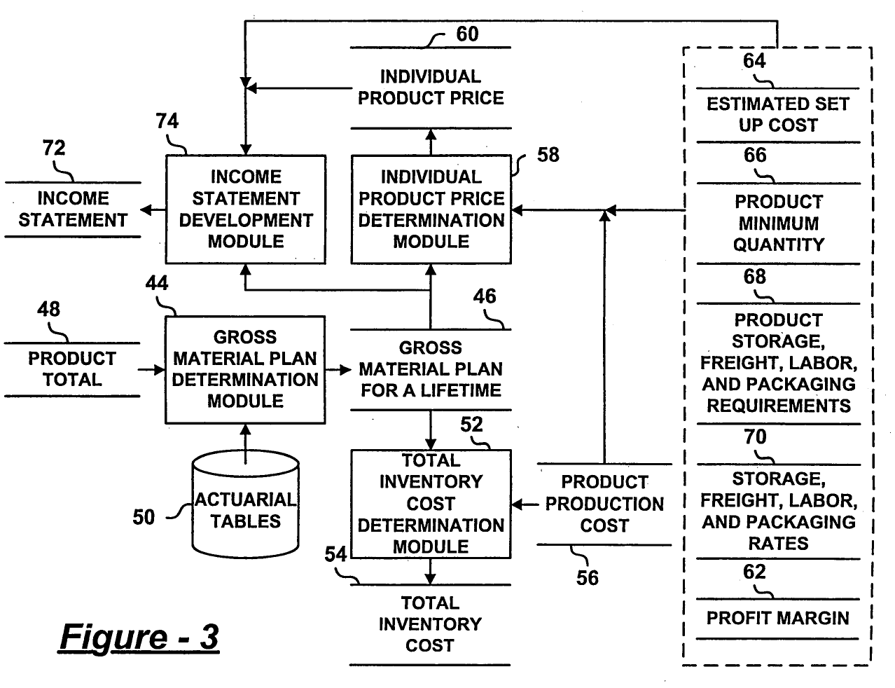

As best observed in FIG. 3, the product forecasting system according to the present invention includes a gross material plan determination module 44. Module 44 is adapted to determine a gross material plan 46 for a lifetime, such as a product service term or portion thereof, based on an estimated product total 48 and a statistically determined probability of failure for the product in question. The probability of failure is preferably provided as a percentage by actuarial tables datastore 50. For example, the product total 48 is multiplied by a percent value to obtain a prediction of a number of replacement products that are likely to be required during a predetermined service term. The gross material plan is scheduled in terms of volume assumptions for fractions of the service term in question, and therefore correspond to a releasing plan. The scheduling function may be linear or non-linear as appropriate to a marketing scheme for the product in question. The gross material plan 46 may be employed in various, additional ways.

The system according to the present invention employs the gross material plan 46 to predict various costs. For example, total inventory cost determination module 52 is adapted to employ gross material plan 46 to predict a total inventory cost 54 relating to the service term or a portion thereof. In so doing, module 52 employs an estimated product production cost 56 to predict the cost of the predicted inventory amount represented by gross material plan 46. Also, individual product price determination module 58 is adapted to predict an individual product price 60 based on the gross material plan 46 in combination with various factors. In so doing, module 58 first determines an individual product cost, and then applies a profit margin 62 to arrive at the individual product price 60. This individual product price 60 is further employed as the basis for a customer quote, such that module 58 doubles as a customer quote development module. The factors employed to determine the product cost include an estimated set up cost 64 for producing a run of the product, a product minimum quantity 66, product storage, freight, labor, and packaging requirements 68, and related product storage, freight, labor, and packaging costs 70.

The inventory forecasting system is also capable of employing the gross material plan 46, the individual product price 60, and the factors employed in determining the individual product cost to develop an income statement. Income statement development module 74 employs the gross material plan 46 to determine a product volume for one or more predetermined periods of time within the service term. Then, module 74 may recompute the product cost for the volume in question and compare it to a sales total that is based on the product price 60 and the product volume.

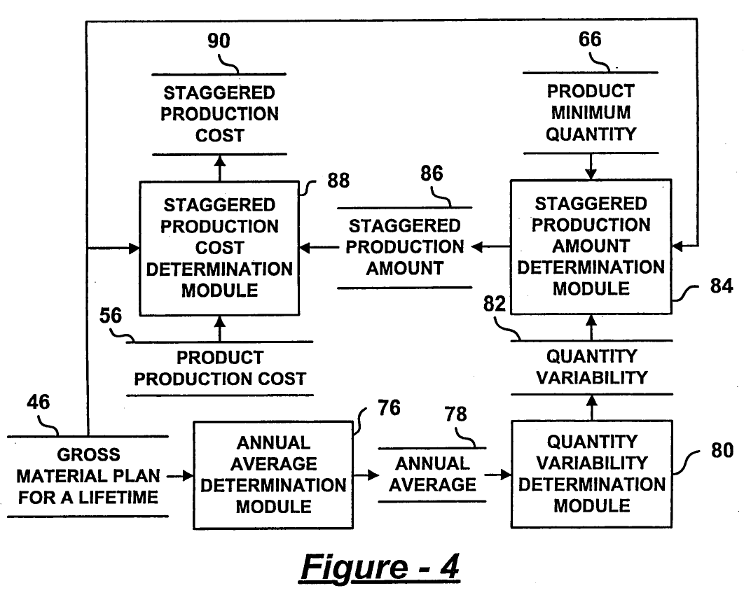

Referring to FIG. 4, details relating to determination of the individual product cost are illustrated as a staggered production cost determination module or sub-system. First, an annual average determination module 76 is adapted to determine an annual average 78 as a fraction of the gross material plan 46. In particular, the gross material plan for the entire lifetime of the service term is divided by a number of years in the entire service term. Then, a quantity variability determination module 80 is adapted to determine a quantity variability 82 as a fraction of the annual average 78. In particular, the annual average is divided by four. Next, a staggered production amount determination module 84 is adapted to determine a staggered production amount 86 based on the gross material plan 46, quantity variability 82 and the product minimum quantity 66. In particular, a summation of the gross material plan 46, quantity variability 82, and product minimum quantity 66 is multiplied by one-hundred thirty-eight percent. Finally, a staggered production cost determination module 88 is adapted to determine a staggered production cost 90 based on the staggered production amount 86, the gross material plan 46, and the product production cost 56. In particular, a mathematical product of the staggered production amount 86 and product production cost 56 is divided by the gross material plan.

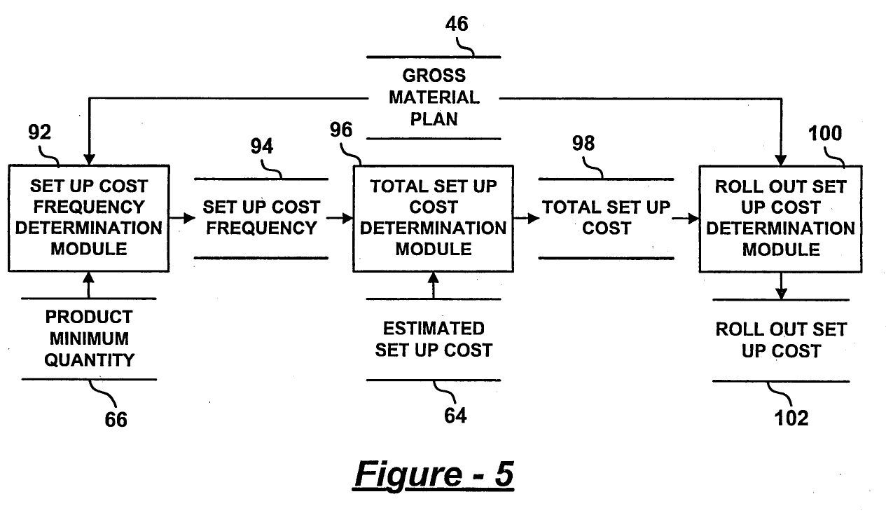

FIG. 5 shows additional details relating to determination of the individual product cost that are illustrated as a roll out set up cost determination module or sub-system. First, a set up cost frequency determination module 92 is adapted to determine a set up cost frequency 94 based on the product minimum quantity 66 and the gross material plan 46. In particular, a fraction of the gross material plan 46 is divided by the product minimum quantity 66. Next, a total set up cost determination module 96 is adapted to determine a total set up cost 98 based on the estimated set up cost 64 and the set up cost frequency 94. In particular, the estimated set up cost 64 is multiplied by the set up cost frequency 94. Finally, a roll out set up cost determination module 100 is adapted to determine a roll out set up cost 102 based on the total set up cost 98 and the gross material plan 46. In particular, a mathematical quotient of the total set up cost 98 and the gross material plan 46 is increased by dividing it by nine-tenths.

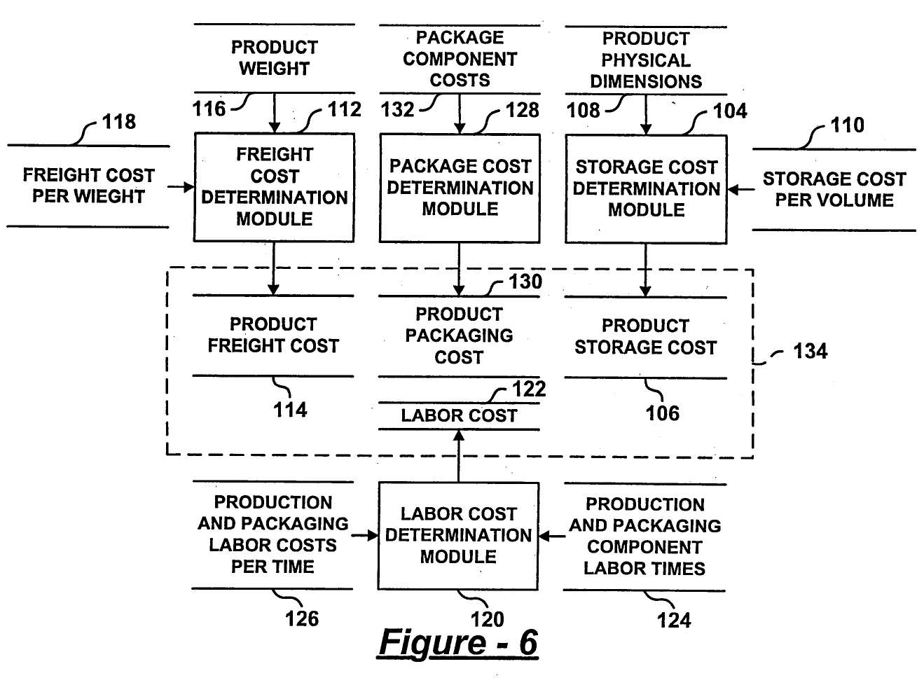

Turning now to FIG. 6, further details relating to determination of the individual product cost are illustrated as a product storage, freight, labor, and packaging costs determination module or sub-system. For example, storage cost determination module 104 determines an individual product storage cost 106 based on product physical dimensions 108 and a storage cost per volume 110. Also, freight cost determination module 112 determines an individual product freight cost 114 based on an individual product weight 116 and a freight cost per weight 118. Further, labor cost determination module 120 determines individual product labor cost 122 based on times 124 required for production and packaging components and based on production and packaging labor costs per time 126. Still further, package cost determination module 128 determines product packaging cost 130 based on costs 132 of package components. Together, product storage cost 106, product freight cost 114, product labor cost 122, and product packaging cost 130 compose the product storage, freight, labor, and packaging costs 134.

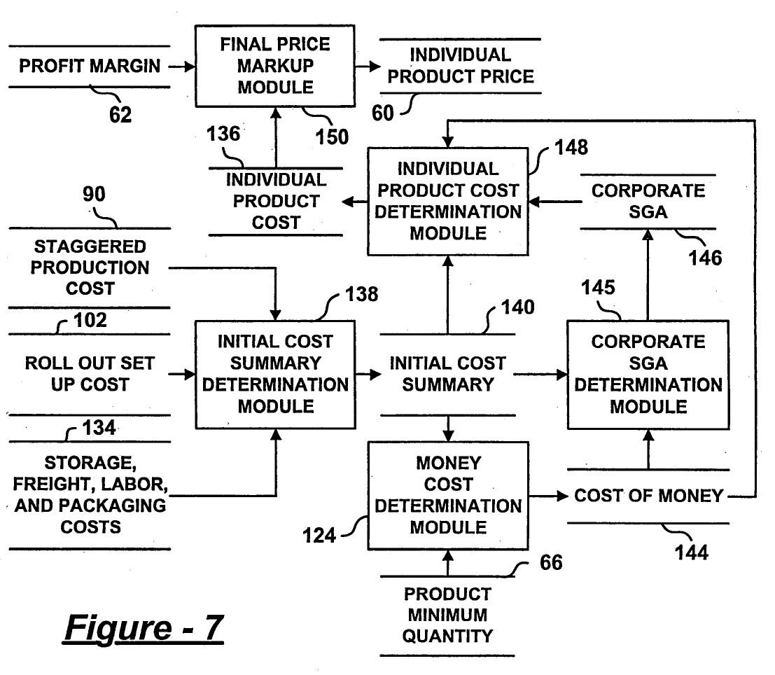

As best observed in FIG. 7, remaining details relating to determination of the individual product cost 136 and individual product price 60 are illustrated as a cost and price determination module or sub-system. First, initial cost summary determination module 138 determines an initial cost summary 140 by adding together the staggered production cost 90, roll out set up cost 102, and storage, freight, labor, and packaging costs 134. Then, a money cost determination module 142 determines a cost of money 144 based on the initial cost summary 140 and the product minimum quantity. In particular, the initial cost summary 140 is divided by the product minimum quantity 66. Next, a corporate Solicitations for Grant Applications (SGA) module 145 determines a corporate SGA 146 based on the initial cost summary 140 and the cost of money 144. In particular, a mathematical sum of the initial cost summary 140 and the cost of money 144 is dived by ten. Subsequently, an individual product cost determination module 148 determines the individual product cost 136 based on the initial cost summary 140, the cost of money 144, and the corporate SGA 146. In particular, the initial cost summary 140, the cost of money 144, and the corporate SGA 146 are mathematically summed. Finally, a final price markup module 150 determines the individual product price 60 based on the individual product cost 136 and the profit margin 62. In particular, the mathematical sum of the initial cost summary 140, the cost of money 144, and the corporate SGA 146 is increased by dividing by seven tenths.

The description of the invention is merely exemplary in nature and, thus, variations that do not depart from the gist of the invention are intended to be within the scope of the invention. In particular, the statistical probabilities of product failure over a lifetime may be defined and organized in various ways made readily apparent to one skilled in the art in view of the preceding disclosure. Also, the gross material plan for a lifetime may be apportioned and utilized in various ways made readily apparent to one skilled in the art in view of the proceeding disclosure. Such variations are not to be regarded as a departure from the spirit and scope of the invention.

1. An inventory forecasting system, comprising:
an input receptive of a product total and a probability of product failure over a predetermined amount of time;
a gross material plan determination module adapted to determine a gross material plan for a lifetime based on the product total and the probability of product failure; and
a development module adapted to develop at least one of:
(a) a releasing plan devised to accomplish automatic release of products to a supply base based on volume assumptions determined as a function of the gross material plan;
(b) a customer quote based on an individual product price determined as a function of the gross material plan; and
(c) an income statement based on the individual product price and a product volume determined as a function of the gross material plan.

2. The system of claim 1, further comprising a datastore containing at least one actuarial table recording statistically averaged probabilities of product failure over the predetermined amount of time, and organized according to at least one of product composition, product location, product sub-system, and product function.

3. The system of claim 2, further comprising at least one actuarial table recording statistically averaged probabilities of vehicle part failure, wherein the statistically averaged probabilities reflect historical data, crash data, and material shelf life, and the probabilities are organized as a function of vehicle part composition, vehicle part location, vehicle part subsystem, and vehicle part function.

4. The system of claim 1, further comprising an inventory cost determination module adapted to determine an inventory cost based on a product production cost and the gross material plan.

5. The system of claim 1, further comprising an individual product price determination module adapted to determine an individual product price based on a product production cost and the gross material plan.

6. The system of claim 1, further comprising:
an annual average determination module adapted to determined an annual average as a fraction of the gross material plan;
a quantity variability determination module adapted to determine a quantity variability as a fraction of the annual average;
a staggered production amount determination module adapted to determine a staggered production amount based on the gross material plan, the quantity variability, and a product minimum quantity; and
a staggered production cost determination module adapted to determine a staggered production cost based on the staggered production amount, the gross material plan, and a product production cost.

7. The system of claim 1, further comprising a roll out set up cost determination module adapted to determine a roll out set up cost based on a product minimum quantity, the gross material plan, and an estimated set up cost.

8. The system of claim 1, further comprising a releasing plan development module adapted to determine the releasing plan by assuming a volume based on the gross material plan and a fraction of the predetermined amount of time.

9. The system of claim 1, further comprising a customer quote development module adapted to develop the customer quote based on a staggered material cost determined as a function of the gross material plan.

10. The system of claim 1, further comprising an income statement development module adapted to develop the income statement.

11. An inventory forecasting system, comprising:
an input receptive of a product total and a probability of product failure over a predetermined amount of time;
a gross material plan determination module adapted to determine a gross material plan for a lifetime based on the product total and the probability of product failure; and
a product cost determination module adapted to determine a product cost based on the gross material plan.

12. The system of claim 11, further comprising a staggered production cost determination module adapted to determine a staggered production cost based on the gross material plan, a product production cost, and a product minimum quantity.

13. The system of claim 11, further comprising a roll out set up cost determination module adapted to determine a roll out set up cost based on the gross material plan, a product minimum quantity, and an estimated set up cost.

14. The system of claim 11, further comprising a storage, freight, labor, and packaging costs determination module adapted to determine product storage, freight, labor, and packaging costs based on the gross material plan, product characteristics relating to storage, freight, labor, and packaging requirements, and related costs.

15. The system of claim 11, wherein said product cost determination module is adapted to determine the product cost based on a staggered production cost, a roll out set up cost, and product storage, freight, labor, and packaging costs.

16. The system of claim 11, further comprising a product price determination module adapted to determine an individual product price based on the product cost and a profit margin.

17. The system of claim 11, further comprising a datastore recording statistically averaged probabilities of product failure over a service term.

18. The system of claim 11, further comprising a releasing plan development module adapted to determine a releasing plan by assuming a volume based on the gross material plan and a fraction of the predetermined amount of time.

19. The system of claim 11, further comprising a customer quote development module adapted to develop a customer quote based on a staggered material cost determined as a function of the gross material plan.

20. The system of claim 11, further comprising an income statement development module adapted to develop an income statement based on the individual product price and a product volume determined as a function of the gross material plan.

21. An inventory forecasting method, comprising:
receiving a product total and a probability of product failure over a predetermined amount of time;
determining a gross material plan for a lifetime based on the product total and the probability of product failure; and
employing the gross material plan to develop at least one of:
(a) a releasing plan adapted to accomplish automatic release of products to a supply base based on volume assumptions determined as a function of the gross material plan;
(b) a customer quote based on an individual product price determined as a function of the gross material plan; and
(c) an income statement based on the individual product price and an estimated product volume determined as a function of the gross material plan.

22. The method of claim 21, further comprising:
developing an actuarial table recording statistically averaged probabilities of product failure over the predetermined amount of time; and
organizing the table according to at least one of product composition, product location, product sub-system, and product function.

23. The method of claim 21, further comprising:
breaking historical data, crash data, and material shelf life data down into data points based on product categories including at least one of product composition, product location, product sub-system, and product function;
analyzing the data points to determine a statistical average a product of the categories will fail over a product service term;
developing at least one actuarial table recording statistically averaged probabilities of product failure;
developing a releasing plan based on the statistically averaged probabilities;
releasing products according to the releasing plan;
tracking anomalies corresponding to deviations from expected results of releasing products according to the releasing plan; and
employing the tracked anomalies as feedback in an actuarial table development and correction process.

24. The method of claim 21, further comprising determining an inventory cost based on a product production cost and the gross material plan.

25. The method of claim 21, further comprising determining an individual product price based on a product production cost and the gross material plan.

26. The method of claim 21, further comprising:
determining an annual average as a fraction of the gross material plan;
determining a quantity variability as a fraction of the annual average;
determining a staggered production amount based on the quantity variability and a product minimum quantity; and
determining a staggered production cost based on the staggered production amount, the gross material plan, and a product production cost.

27. The method of claim 21, further comprising determining a roll out set up cost based on a product minimum quantity, the gross material plan, and an estimated set up cost.

28. The method of claim 21, further comprising determining the releasing plan by assuming a volume based on the gross material plan and a fraction of the predetermined amount of time.

29. The method of claim 21, further comprising developing the customer quote based on a staggered material cost determined as a function of the gross material plan.

30. The method of claim 1, further comprising developing the income statement.

31. An inventory forecasting method, comprising:
receiving a product total and a probability of product failure over a predetermined amount of time;
determining a gross material plan for a lifetime based on the product total and the probability of product failure; and
determining a product cost based on the gross material plan.

32. The method of claim 31, further comprising determining a staggered production cost based on the gross material plan, a product production cost, and a product minimum quantity.

33. The method of claim 31, further comprising determining a roll out set up cost based on the gross material plan, a product minimum quantity, and an estimated set up cost.

34. The method of claim 31, further comprising determining product storage, freight, labor, and packaging costs based on the gross material plan, product characteristics relating to storage, freight, labor, and packaging requirements, and related costs.

35. The method of claim 31, further comprising determining the product cost based on a staggered production cost, a roll out set up cost, and product storage, freight, labor, and packaging costs.

36. The method of claim 31, further comprising determining an individual product price based on the product cost and a profit margin.

37. The method of claim 31, further comprising recording statistically averaged probabilities of product failure over a service term.

38. The method of claim 31, further comprising determining a releasing plan by assuming a volume based on the gross material plan and a fraction of the predetermined amount of time.

39. The method of claim 31, further comprising developing a customer quote based on a staggered material cost determined as a function of the gross material plan.

40. The method of claim 31, further comprising developing an income statement based on the individual product price and a product volume determined as a function of the gross material plan.

41. An inventory forecasting method, comprising:
breaking at least one of historical data, crash data, and material shelf life data down into data points based on product categories including at least one of product composition, product location, product sub-system, and product function;
analyzing the data points to determine a statistical average a product of the categories will fail over a product service term;
developing at least one actuarial table recording statistically averaged probabilities of product failure.

42. The method of claim 41, further comprising developing a releasing plan based on the statistically averaged probabilities.

43. The method of claim 42, further comprising releasing products according to the releasing plan.

44. The method of claim 42, further comprising tracking anomalies corresponding to deviations from expected results of releasing products according to the releasing plan.

45. The method of claim 42, employing tracked anomalies in results of releasing products according to the releasing plan as feedback in an actuarial table development and correction process.

46. An automotive vehicle part inventory forecasting method, comprising:
accessing an actuarial table populated with statistically averaged probabilities of automotive vehicle part failure over a predetermined period of time;
receiving a total number relating to an automotive vehicle part under service during a service term; and
generating a gross material plan based on the total number and a statistically averaged probability of failure relating to the automotive vehicle part under service, wherein the gross material plan specifies a likely number of required replacement parts during at least one of the service term and a portion thereof.

47. The method of claim 46, further comprising determining an individual replacement part price as a function of the gross material plan.

48. The method of claim 47, further comprising determining at least one of a customer quote and an income statement based on the individual product price and an estimated product volume determined as a function of the gross material plan.

49. The method of claim 46, further comprising feeding the gross material plan into a releasing plan adapted to accomplish automatic release of replacement automotive vehicle parts to a supply base in accordance with the gross material plan.

50. The method of claim 46, further comprising accessing the table based on automotive vehicle part composition, location of the automotive vehicle part on the automotive vehicle, membership of the automotive vehicle part in an automotive vehicle part sub-system, and a function of the automotive vehicle part in a context of the automotive vehicle.
